(19) United States
(12) Patent Application Publication
(10) Pub. No.: US 2011/0119609 A1
(43) Pub. Date: May 19, 2011

(54) Docking User Interface Elements

(75) Inventors: Nikhil Bhatt, Cupertino, CA (US); Mark Lee Kawano, San Mateo, CA (US); Craig Matthew Milito, Sunnyvale, CA (US)

(73) Assignee: APPLE INC., Cupertino, CA (US)

(21) Appl. No.: 12/619,522

(22) Filed: Nov. 16, 2009

(51) Int. Cl. G06F 3/048

(52) U.S. Cl. 715/765; 715/766

(57) ABSTRACT

Methods, systems, and apparatus for managing elements in a user interface for a software application executing on a computer system include displaying a user interface having separate elements including at least an image browser element for viewing preview thumbnails of available images, an image viewer element for accessing a selected image and a Heads-Up Display (HUD) element that displays metadata for the selected image; receiving user input requesting that the HUD element be moved from a current location in the user interface to a destination location in the user interface; and modifying the displayed user interface by moving the HUD element to the destination location and selectively altering a size or location or both of one or both of the image browser element and the image viewer element to accommodate display of the HUD element at the destination location in the user interface.

### BACKGROUND

This disclosure relates to docking graphical user interface elements, for example, a Heads-Up Display (HUD) element.

A graphical user interface (GUI) provides users of computers and other electronic devices a collection of visible tools with which a user can interact (e.g., via a keyboard, mouse, touch screen, light pen) to perform computer tasks. GUIs can be designed for specific purposes, such as a word processor, in which the GUI can present a paper-like interface and collections of tools for performing tasks such as altering the font or color of a selected passage of text.

Collections of related GUI tools can be grouped together as toolbars. These tool bars can be presented as bands of graphical icons that are positioned along a side of the GUI (e.g., docked at an edge of the interface), or can “float” at an arbitrary position within the GUI. Some implementations allow for toolbars to be moved between “docked” and “floating” configurations to give the user some control over the location of various groupings of GUI tools.

### SUMMARY

In general, in one aspect, the subject matter can be implemented to include methods, systems, and/or a computer-readable medium encoded with a computer program for managing elements in a user interface for a software application executing on a computer system. Implementations may include one or more of the following features.

Managing user interface elements may be accomplished by displaying a software application user interface having multiple separate elements including at least a first element and a second element, receiving user input requesting relocation of the first element from a first location in the user interface to a second location in the user interface, and modifying the displayed user interface by moving the first element to the second location and selectively altering an appearance of the second element to accommodate display of the first element at the second location in the user interface.

The first element may include a dockable Heads-Up Display (HUD) that, for example, displays meta-data for an item of media content such as a digital still image or digital video. The second element may include at least one of a media display element and a media editing element. Altering an appearance of the second element may include one or both of resizing and relocating the second element sufficiently such that no overlap occurs between the altered second element and the first element at the second location.

Managing user interface elements may further include receiving user input requesting relocation of the first element back to the first location, and modifying the displayed user interface by moving the first element back to the first location and selectively altering an appearance of the second element to accommodate display of the first element at the first location in the user interface.

The user interface further may include at least a third element and wherein modifying the displayed user interface comprises moving the first element to the second location and selectively altering an appearance of one or both of the second element and the third element to accommodate display of the first element at the second location in the user interface.

Receiving user input requesting relocation of the first element may include receiving an indication that the user has clicked on a docking button displayed in conjunction with the first element

Relocating a user interface element may include moving the first element to a closest vertical edge of the user interface or a closest vertical edge of the user interface that is not already occupied by another element.

In another aspect, a system for managing user interface elements may include a storage device for storing media content including digital images, and a computing device communicatively coupled with the storage device. The computing device may execute a digital image manipulation application that is configured to perform operations including displaying a digital image manipulation application user interface that has a plurality of separate elements including at least a first element and a second element; receive user input requesting relocation of the first element from a first location in the user interface to a second location in the user interface; and modify the displayed user interface by moving the first element to the second location and altering an appearance of the second element to accommodate display of the first element at the second location in the user interface. Additionally, or alternatively, the system may include any of the other aspects described herein.

In another aspect, methods, systems, and a computer-readable medium for managing elements in a user interface may include displaying a user interface having separate elements including at least an image browser element for viewing preview thumbnails of available images, an image viewer element for accessing a selected image and a Heads-Up Display (HUD) element that displays metadata for the selected image; receiving user input requesting that the HUD element be moved from a current location in the user interface to a destination location in the user interface; and modifying the displayed user interface by moving the HUD element to the destination location and selectively altering a size or location or both of one or both of the image browser element and the image viewer element to accommodate display of the HUD element at the destination location in the user interface. The current location may include a floating location within the user interface and the destination location may include a docked location at an edge of the user interface, or vice versa. Additionally, or alternatively, the computer-readable medium may include any of the other aspects described herein.

The subject matter described in this specification can be implemented to realize one or more of the following potential advantages. For example, a user interface implemented according to the subject matter of this document may provide a robust and uncluttered user interface in which user interface elements can be automatically (e.g., without further user input or intervention) resized, relocated and/or rearranged in a visually appealing manner to accommodate a user request to move a first user interface element from an undocked position (e.g., floating within the user interface) to a docked position (e.g., visually attached to border of the user interface). As a result, the user tends to be able to accomplish tasks quicker and easier and without having to encounter or manually adjust for screen clutter caused by overlapping or inconveniently positioned user interface elements.

The details of one or more implementations are set forth in the accompanying drawings and the description below. Other features and potential advantages will be apparent from the description and drawings, and from the claims.

### BRIEF DESCRIPTION OF THE DRAWINGS

FIG. 1 is an example of a graphical user interface with movable elements.

FIG. 2 is an example of the graphical user interface wherein the movable elements have been relocated.

FIG. 3 is an example of the graphical user interface wherein the movable elements have been relocated in another example configuration.

FIG. 4 is an example of the graphical user interface wherein the movable elements have been relocated in yet another example configuration.

FIG. 5 is a flowchart of a process for modifying GUI elements in response to one of the elements being moved.

FIG. 6 is a block diagram of a computing device and system that can be used to implement techniques described with respect to FIGS. 1-5.

FIG. 7 is a block diagram of another computing device and system that can be used, e.g., to manage the display of movable elements of a user interface as described with respect to FIGS. 1-5.

Like reference symbols indicate like elements throughout the specification and drawings.

### DETAILED DESCRIPTION

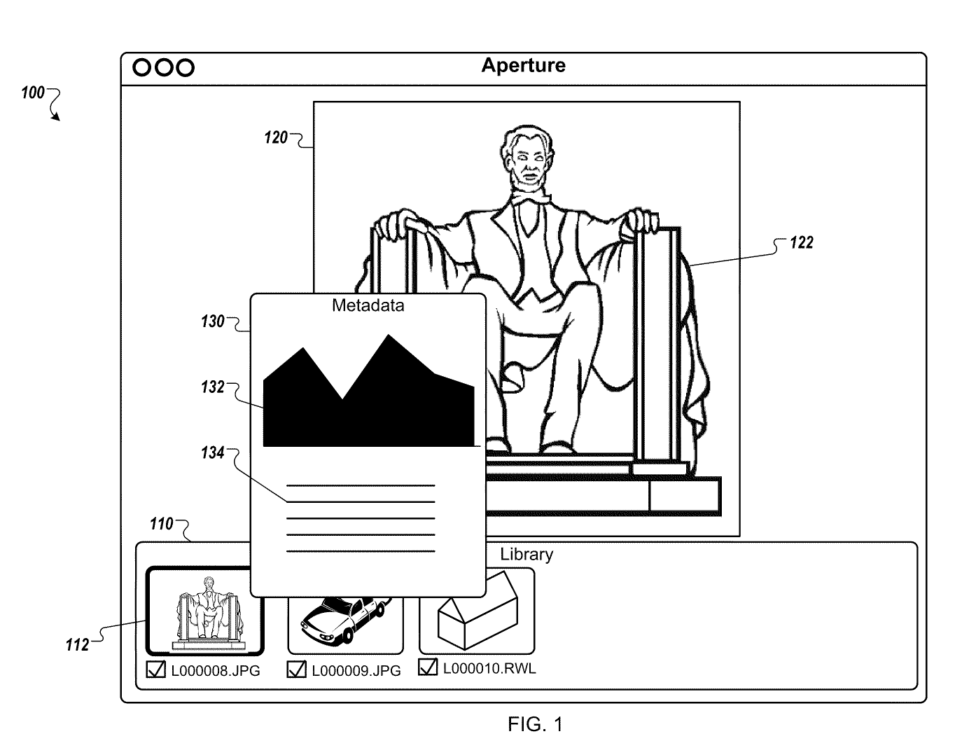

FIG. 1 is an example of graphical user interface (GUI) 100 with movable elements. The GUI 100 includes image browsing element 110 that is docked (e.g., removably connected) along a bottom edge of the GUI 100. The movable image browsing element 110 includes a collection of image thumbnails such as image thumbnail 112 for previewing a collection of available images. In the illustrated example, the user has selected the image thumbnail 112, and movable image viewer element 120 displays image 122 represented by the image thumbnail 112. In some implementations, the movable image viewer element 120 can also provide an interface for editing images in addition to viewing them.

Movable metadata element 130 includes information about the image 122, such as histograph 132 and a collection of data 134 associated with the image 122. For example, the collection of data 134 can describe the image's 122 name, location where the image 122 was taken, the shutter speed used, the f-stop setting used, or other information that can be associated with the image 122. In the illustrated example, the movable metadata element 130 is depicted as a floating element (e.g., the movable metadata element 130 is movable to partly overlay other elements of the GUI 100). In some implementations, the movable metadata element 130 can be a heads up display (HUD) that displays information related to other elements of the GUI 100 or objects displayed therein. For example, the HUD can display color balance or luminosity properties of a displayed digital still image in a digital image manipulation application (e.g., an image editing application), time code information for a digital video, or word counts and readability statistics in a word processing application.

While the GUI 100 depicts an image browsing or editing application, it should be noted that the GUI is not limited to imaging applications. In some implementations the GUI 100 can be an interface to a word processor, spreadsheet, a web browser, a media player, a file browser, or other type of software application. For example, a word processor can include a text editing element as well as elements that include tools for formatting or reviewing text.

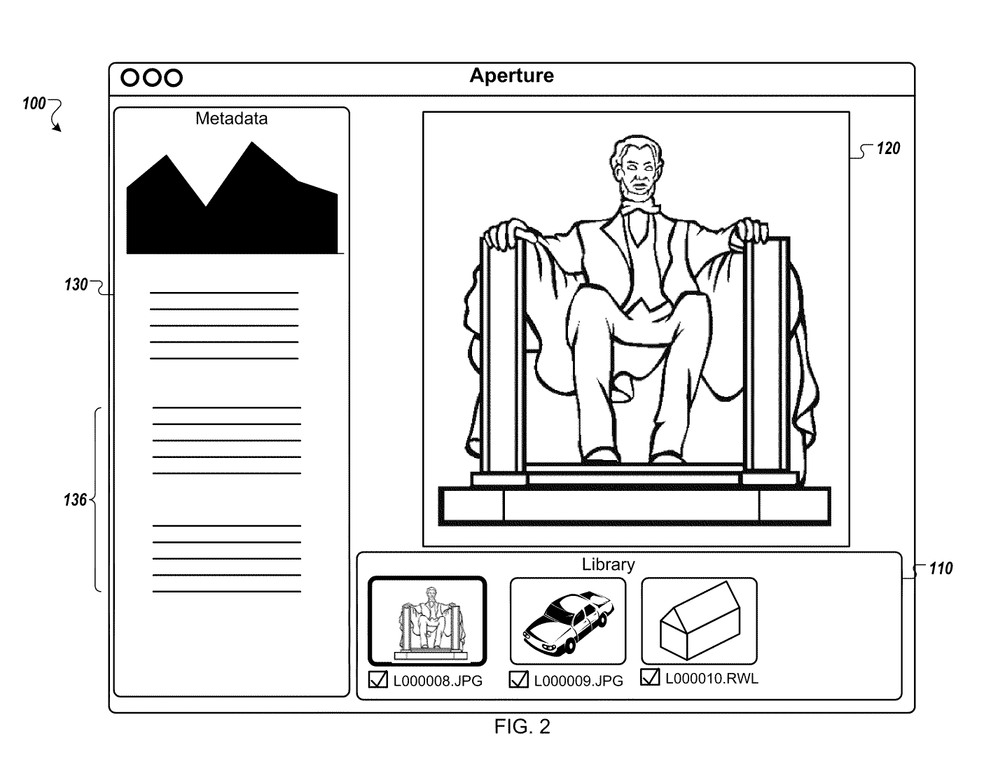

FIG. 2 is an example of the graphical user interface 100 wherein the movable elements 110, 120, and 130 have been relocated. In some implementations, positioning a element adjacent to an edge of the GUI 100 can cause the element to attach itself to the adjacent edge of the GUI 100 (e.g., the element becomes “docked” or “locked”). In the illustrated example, a user has moved the metadata element 130 from its position as depicted in FIG. 1 to the left edge of the GUI 100 (e.g., by dragging the movable metadata element 130 with a mouse). This act of relocation causes the movable metadata element 130 to dock with the left edge of the GUI 100. An element of the docking process is that the movable metadata element 130 enlarges to occupy substantially the entire vertical area of the left edge of the GUI 100 to reveal an additional collection of metadata 136.

In some implementations, the movable elements 110, 120, and 130 can be docked or undocked through use of a docking button. For example, the movable elements 110, 120, and 130 can include an icon that, when clicked by the user, can cause the element to be resized and/or relocated. When the icon is clicked on a floating tool bar, the tool bar can move to dock with the closest vertical edge of the GUI 100. In some implementations, when the icon is clicked on a floating tool bar, the tool bar can dock with a closest vertical edge of the GUI 100 that is not already occupied by another docked tool bar. In another example, when the icon is clicked on a docked tool bar, the tool bar can detach from the edge to become a floating tool bar once again.

In some implementations, docked elements can be prevented from overlaying or obscuring other elements. For example, in the docked state the movable metadata element 130 can partly overlay the movable image browser element 110 and the movable image viewer element 120 as they were depicted in FIG. 1. To avoid this situation, the movable image browser element's 110 width is reduced to accommodate the width of the movable metadata element 130, as is depicted in FIG. 2. The movable image viewing element 120 is also shifted right from its position in FIG. 1 to accommodate the repositioned movable metadata element 130.

In some implementations, docking, locking, undocking, unlocking, resizing, and relocation processes can be presented as smooth animations. For example, when the user docks the movable metadata element 130 with the left edge of the GUI 100, the user may see the movable metadata element 130 grow from its original size (e.g., as depicted in FIG. 1) to the dimensions as depicted in FIG. 2. Movable elements 110 and 120 also can be resized and relocated in a similar manner, as to present the user with an appealing visual display wherein the movable elements 110, 120, and 130 grow, shrink, and shift position fluidly and substantially simultaneously as the user manipulates the movable elements 110, 120, and 130.

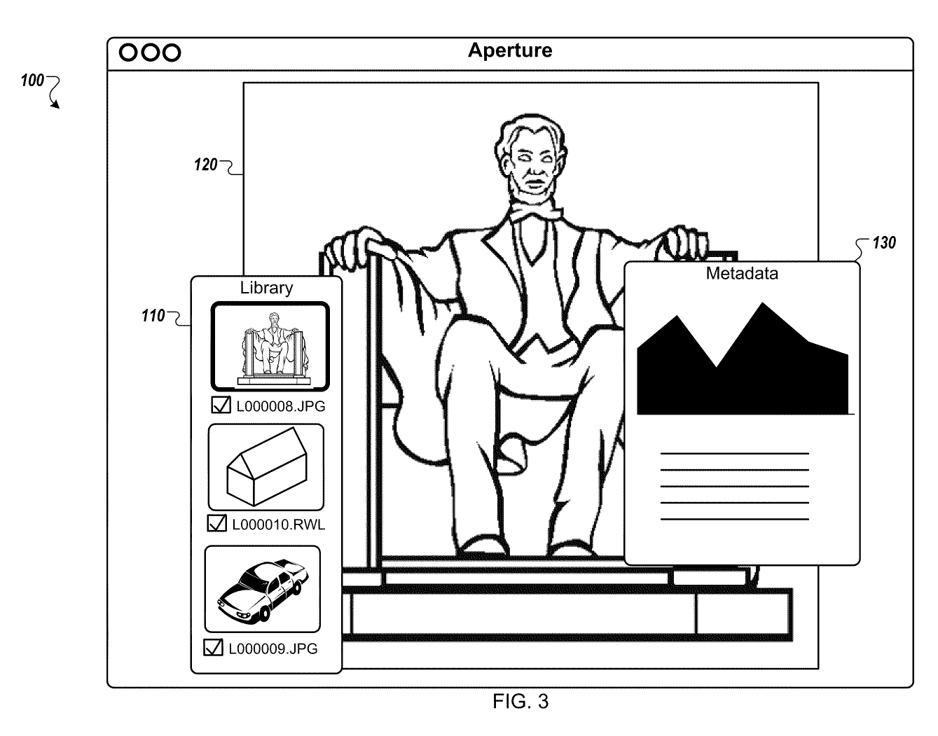

FIG. 3 is an example of the graphical user interface 100 wherein the movable elements 110, 120, and 130 have been relocated in another example configuration. In the illustrated example, the movable metadata element 130 has been undocked from the edge of the GUI 100, thereby making the movable metadata element 130 into a floating element that can at least partly overlay or obscure objects behind it. In the illustrated example, the movable metadata element 130 is also reduced in size (e.g., to substantially the same dimensions it had as depicted in FIG. 1). The movable image browser element 110 has also been undocked from its position along the bottom edge of the GUI 100. As part of the undocking process, the movable image browser element 110 has been resized, and can at least partly overlay or obscure objects behind it. In response to the movable elements 110 and 130 being undocked, the movable image viewer element 120 is shifted to become re-centered within the GUI 100, and is enlarged (e.g., scaled up) to occupy substantially the entire area of the GUI 100.

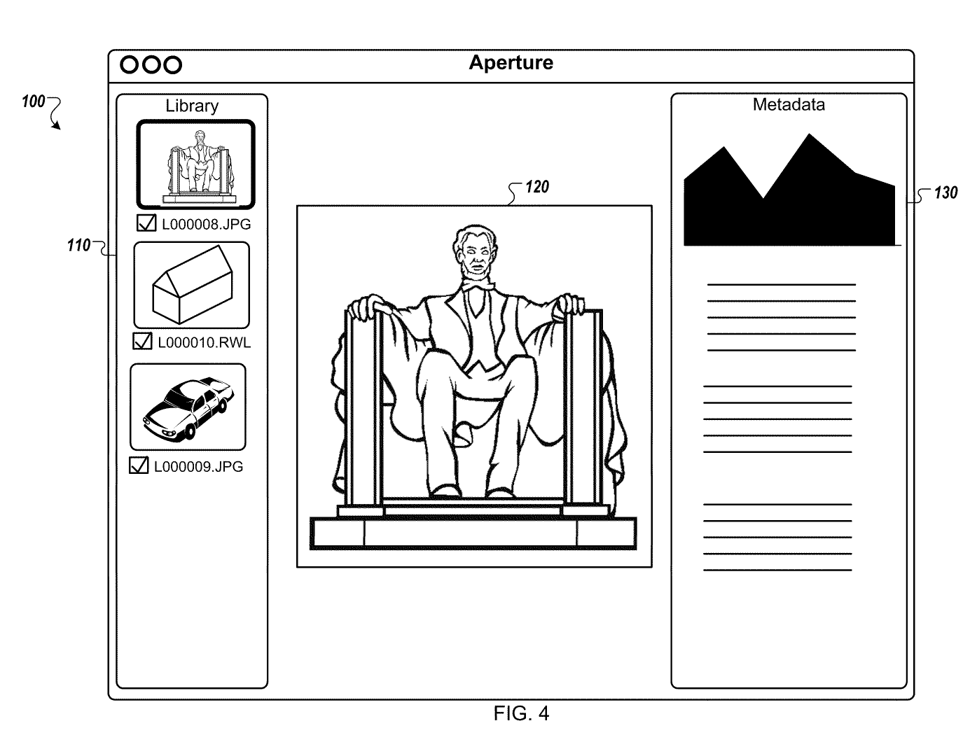

FIG. 4 is an example of the graphical user interface 100 wherein the movable elements 110, 120, and 130 have been relocated in yet another example configuration. In the illustrated example the movable metadata element 130 has been docked (e.g., locked) with the right edge of the GUI 100, and is expanded to occupy substantially the entire vertical area of the right side of the GUI 100. The movable image browser 110 has been docked with the left edge of the GUI 100, and is expanded to occupy substantially the entire left side of the GUI 100. In response to these dockings, the movable image viewer element 120 is reduced (e.g., scaled down) and shifted so as to no be obscured by the movable elements 110 or 130.

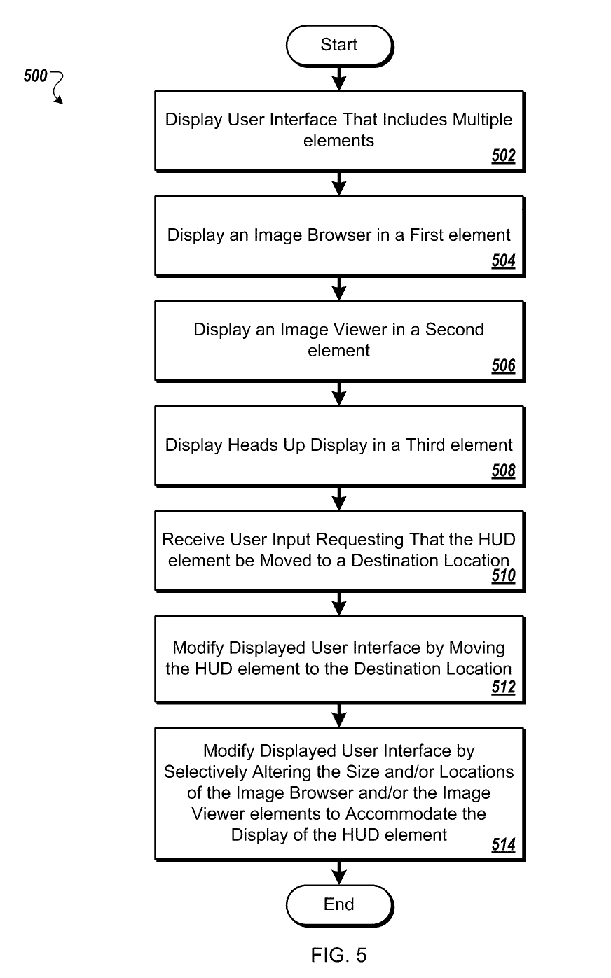

FIG. 5 is a flowchart of a process for modifying GUI elements in response to one of the elements having been relocated. The first step 502 in the process 500 is the display of a user interface. In some implementations, the user interface can be the GUI 100 of FIGS. 1-4.

Next, at step 504, an image browser is displayed in a first element. For example, the image browser can be displayed as a floating or docked tool bar within the user interface. At step 506, an image viewer is displayed in a second element, and at step 508 a heads up display (HUD) is displayed in a third element. In some implementations, the HUD can be a element that displays metadata or other information that describes properties of media content or other types of objects displayed in other elements. For example the HUD can display size, resolution, color depth, or other information about a digital still image or digital video displayed by the image viewer in step 506.

In step 510, a user input requesting that the HUD element be moved to a destination location is received. In response to the user request of step 510, the displayed user interface is modified in step 512 by moving the HUD element to the destination location. For example, in step 510 the HUD may be displayed as a floating tool bar, and the user can click on a docking button on the HUD to dock (e.g., lock) the HUD with and edge in step 512. In another example, the HUD may be displayed as a docked tool bar, and in step 510 the user can click the docking button on the HUD to undock the HUD to become a floating tool bar once again.

In step 514, the displayed user interface is modified by selectively altering the size and/or locations of the image browser and/or the image viewer elements to accommodate the display of the HUD element. In some implementations, as depicted in FIGS. 1-4, when one or more elements are moved, docked, or undocked, the remaining elements can shift vertically or horizontally so as not to be obscured by the moved element, or to take advantage of space made available when a element is moved.

In some implementations, as also depicted in FIGS. 1-4, when one or more elements are moved, docked, or undocked, the remaining elements can be resized so as not to be obscured by the moved element, or to take advantage of the space made available when a element is moved. For example, in a comparison of FIGS. 1 and 2, the movable image browser element 110 shrinks horizontally and the movable image view element 120 shifts rightward to accommodate the docked movable metadata element 130. In another example, in a comparison of FIGS. 2 and 3, the movable image viewer element 120 is shifted vertically and horizontally to become substantially centered in the GUI 100, and is scaled up to take advantage of the space made available when the movable elements 110 and 130 are undocked.

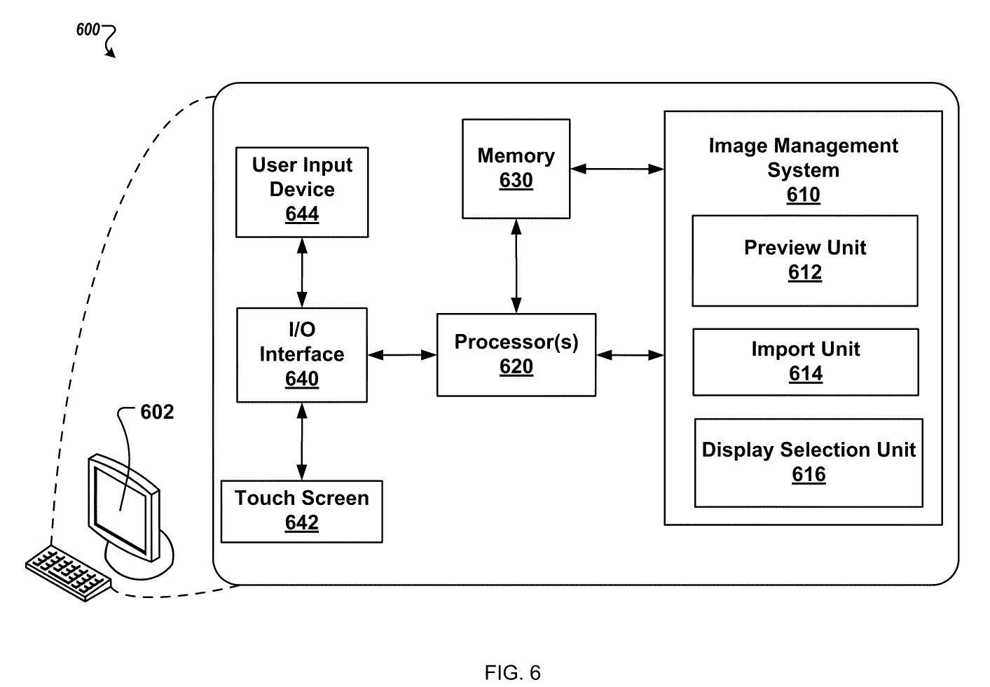

FIG. 6 is a block diagram of a computing device and system 600 that can be used to implement the techniques described with respect to FIGS. 1-5. The system 600 can include a processor 620 to control operation of the system 600 including executing any machine or computer readable instructions. The processor 620 can communicate with a memory or data storage unit 630 that can store data, such as image files and machine or computer readable instructions. Also, the processor 620 can communicate with an image management system 610 to manage different image files including import, export, storage, image adjustment, metadata application and display of the image files. The processor 620 can communicate with an input/output (I/O) interface 640 that can interface with different input devices, output devices or both. For example, the I/O interface 640 can interface with a touch screen 642 on a display device 602. Also, the I/O interface 640 can interface with a user input device 644 such as a keyboard, a mouse, a trackball, etc. that are designed to receive input form a user.

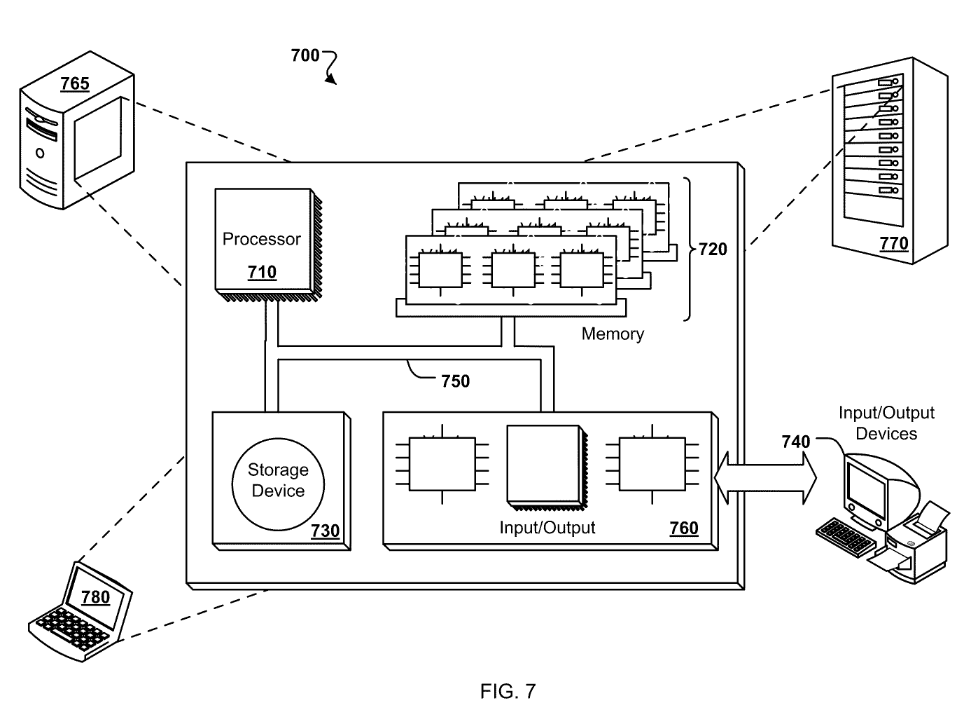

FIG. 7 is a block diagram of another computing device and system that can be used, e.g., to manage the display of movable elements of a user interface as described with respect to FIGS. 1-5. Computing device 700 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

Computing device 700 includes a processor 710, memory 720, a storage device 730, a high-speed interface 750 connecting to memory 720. The computing device can also include high-speed expansion ports (not shown), and a low speed interface (not shown) connecting to low speed bus (not shown) and storage device 730. Each of the components 710, 720, 730, 750, and 720, are interconnected using various busses, and can be mounted on a common motherboard or in other manners as appropriate. The processor 710 can process instructions for execution within the computing device 700, including instructions stored in the memory 720 or on the storage device 730 to display graphical information for a GUI on an external input/output device, such as display 740 coupled to an input/output interface 760. In other implementations, multiple processors and/or multiple buses can be used, as appropriate, along with multiple memories and types of memory. Also, multiple computing devices 700 can be connected, with each device providing portions of the necessary operations (e.g., as a server bank, a group of blade servers, or a multi-processor system).

The memory 720 stores information within the computing device 700. In one implementation, the memory 720 is a computer-readable medium. In one implementation, the memory 720 is a volatile memory unit or units. In another implementation, the memory 720 is a non-volatile memory unit or units.

The storage device 730 is capable of providing mass storage for the computing device 700. In one implementation, the storage device 730 is a computer-readable medium. In various different implementations, the storage device 730 can be a floppy disk device, a hard disk device, an optical disk device, or a tape device, a flash memory or other similar solid state memory device, or an array of devices, including devices in a storage area network or other configurations. The computer program product contains instructions that, when executed, perform one or more methods, such as those described above. The computer- or machine-readable medium can include the memory 720, the storage device 730, memory on processor 710, or a propagated signal.

The high speed controller 750 manages bandwidth-intensive operations for the computing device 700, while the low speed controller manages lower bandwidth-intensive operations. Such allocation of duties is exemplary only. In one implementation, the high-speed controller 750 is coupled to memory 720, display 740 (e.g., through a graphics processor or accelerator), and to high-speed expansion ports (not shown), which can accept various expansion cards (not shown). In the implementation, low-speed controller (not shown) is coupled to storage device 730 and low-speed expansion port (not shown). The low-speed expansion port, which can include various communication ports (e.g., USB, Bluetooth, Ethernet, wireless Ethernet) can be coupled to one or more input/output devices, such as a keyboard, a pointing device, a scanner, or a networking device such as a switch or router, e.g., through a network adapter.

The computing device 700 can be implemented in a number of different forms, as shown in the figure. For example, it can be implemented as a standard server 765, or multiple times in a group of such servers. It can also be implemented as part of a rack server system 770. In addition, it can be implemented in a personal computer such as a laptop computer 780.

Implementations of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible computer or machine readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, or declarative or procedural languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described is this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Only a few implementations and examples are described and other implementations, enhancements and variations can be made based on what is described and illustrated in this application.

What is claimed is:

1. A method performed by a computer system, the method comprising:
displaying a user interface for a software application, the user interface having a plurality of separate elements including at least a first element and a second element;
receiving user input requesting relocation of the first element from a first location in the user interface to a second location in the user interface; and
modifying the displayed user interface by moving the first element to the second location and selectively altering an appearance of the second element to accommodate display of the first element at the second location in the user interface.

2. The method of claim 1 in which the first element comprises a dockable Heads-Up Display (HUD).

3. The method of claim 2 in which the HUD displays meta-data for an item of media content.

4. The method of claim 3 in which the item of media content comprises a digital still image or digital video.

5. The method of claim 1 in which the second element comprises at least one of a media display element and a media editing element.

6. The method of claim 1 wherein altering an appearance of the second element comprises one or both of resizing and relocating the second element sufficiently such that no overlap occurs between the altered second element and the first element at the second location.

7. The method of claim 1 further comprising:
receiving user input requesting relocation of the first element back to the first location; and
modifying the displayed user interface by moving the first element back to the first location and selectively altering an appearance of the second element to accommodate display of the first element at the first location in the user interface.

8. The method of claim 1 wherein the user interface further comprises at least a third element and wherein modifying the displayed user interface comprises moving the first element to the second location and selectively altering an appearance of one or both of the second element and the third element to accommodate display of the first element at the second location in the user interface.

9. The method of claim 1 wherein receiving user input requesting relocation of the first element comprises receiving an indication that the user has clicked on a docking button displayed in conjunction with the first element

10. The method of claim 1 wherein relocating comprises moving the first element to a closest vertical edge of the user interface.

11. The method of claim 1 wherein relocating comprises moving the first element to a closest vertical edge of the user interface that is not already occupied by another element.

12. A system comprising:
a storage device for storing media content including a plurality of digital images; and
a computing device communicatively coupled with the storage device, wherein the computing device is configured to execute a digital image manipulation application that is configured to perform operations comprising:
display a user interface for the digital image manipulation application, the user interface having a plurality of separate elements including at least a first element and a second element;
receive user input requesting relocation of the first element from a first location in the user interface to a second location in the user interface; and
modify the displayed user interface by moving the first element to the second location and altering an appearance of the second element to accommodate display of the first element at the second location in the user interface.

13. The system of claim 12 in which the first element comprises a dockable Heads-Up Display (HUD).

14. The system of claim 13 in which the HUD displays meta-data for an item of media content.

15. The system of claim 14 in which the item of media content comprises a digital still image or digital video.

16. The system of claim 12 in which the second element comprises at least one of a media display element and a media editing element.

17. The system of claim 12 wherein altering an appearance of the second element comprises one or both of resizing and relocating the second element sufficiently such that no overlap occurs between the altered second element and the first element at the second location.

18. The system of claim 12 wherein the digital image manipulation application further comprises instructions to:
receive user input requesting relocation of the first element back to the first location; and
modify the displayed user interface by moving the first element back to the first location and selectively altering an appearance of the second element to accommodate display of the first element at the first location in the user interface.

19. The system of claim 12 wherein the user interface further comprises at least a third element and wherein modifying the displayed user interface comprises moving the first element to the second location and selectively altering an appearance of one or both of the second element and the third element to accommodate display of the first element at the second location in the user interface.

20. The system of claim 12 wherein receiving user input requesting relocation of the first element comprises receiving an indication that the user has clicked on a docking button displayed in conjunction with the first element

21. The system of claim 12 wherein relocating comprises moving the first element to a closest vertical edge of the user interface.

22. The system of claim 12 wherein relocating comprises moving the first element to a closest vertical edge of the user interface that is not already occupied by another element.

23. A method performed by an image editing software application executing on a computer system, the method comprising:
displaying a user interface for the image editing software application, the user interface having a plurality of separate elements including at least an image browser element for viewing preview thumbnails of a plurality of available images, an image viewer element for accessing a selected image and a Heads-Up Display (HUD) element that displays metadata for the selected image;
receiving user input requesting that the HUD element be moved from a current location in the user interface to a destination location in the user interface; and
modifying the displayed user interface by moving the HUD element to the destination location and selectively altering a size or location or both of one or both of the image browser element and the image viewer element to accommodate display of the HUD element at the destination location in the user interface.

24. The method of claim 23 wherein the current location comprises a floating location within the user interface and the destination location comprises a docked location at an edge of the user interface.

25. The method of claim 23 wherein the destination location comprises a floating location within the user interface and the current location comprises a docked location at an edge of the user interface.

26. A computer-readable medium encoded with a computer program, the computer program comprising instructions that when executed by a processor of a computing device cause the processor to perform operations comprising:
display a user interface for the computer program, the user interface having a plurality of separate elements including at least a first element that displays metadata for a selected media item and a second element for accessing the selected media item;
receive user input requesting that the first element be moved from a current location in the user interface to a destination location in the user interface; and
modify the displayed user interface by moving the first element to the destination location and selectively altering a size or location or both of the second element to accommodate display of the first element at the destination location in the user interface.

27. The medium of claim 26 wherein the current location comprises a floating location within the user interface and the destination location comprises a docked location at an edge of the user interface.

28. The medium of claim 26 wherein the destination location comprises a floating location within the user interface and the current location comprises a docked location at an edge of the user interface.

29. The medium of claim 26 in which the first element comprises a dockable Heads-Up Display (HUD).

30. The medium of claim 26 in which the second element comprises at least one of a media display element and a media editing element.

31. The medium of claim 26 wherein altering an appearance of the second element comprises one or both of resizing and relocating the second element sufficiently such that no overlap occurs between the altered second element and the first element at the second location.

32. The medium of claim 26 further comprising instructions to:
receive user input requesting relocation of the first element back to the first location; and
modify the displayed user interface by moving the first element back to the first location and selectively altering an appearance of the second element to accommodate display of the first element at the first location in the user interface.

33. The medium of claim 26 wherein the user interface further comprises at least a third element and wherein modifying the displayed user interface comprises moving the first element to the second location and selectively altering an appearance of one or both of the second element and the third element to accommodate display of the first element at the second location in the user interface.

34. The medium of claim 26 wherein receiving user input requesting relocation of the first element comprises receiving an indication that the user has clicked on a docking button displayed in conjunction with the first element

35. The medium of claim 26 wherein relocating comprises moving the first element to a closest vertical edge of the user interface.

36. The medium of claim 26 wherein relocating comprises moving the first element to a closest vertical edge of the user interface that is not already occupied by another element.
